(19) United States
(12) Patent Application Publication
(10) Pub. No.: US 2017/0211412 A1
(43) Pub. Date: Jul. 27, 2017

(54) SYSTEM FOR MAINTAINING AN AIRCRAFT TURBINE ENGINE

(71) Applicant: SAFRAN AERO BOOSTERS S.A., Herstal (Milmort) (BE)

(72) Inventors: Nicolas Raimarckers, Tourinne (BE); Vincent Thomas, Hognoul (BE); Bruno Servais, Braives (BE)

(73) Assignee: SAFRAN AERO BOOSTERS S.A., Herstal (Milmort) (BE)

(21) Appl. No.: 15/410,507

(22) Filed: Jan. 19, 2017

(30) Foreign Application Priority Data
Jan. 21, 2016 (BE) 2016/5046

(51) Int. Cl. F01D 21/00; B64F 5/40

(52) U.S. Cl. CPC F01D 21/003; B64F 5/40

(57) ABSTRACT

System for maintaining a turbine engine comprising said turbine engine of an aircraft comprising: an oil reservoir, a sensor able to measure an oil level in the oil reservoir, a transmission device, such as electrical wires, wireless transmitter circuit, etc., for transmitting a signal coupled to said sensor in order to transmit information relating to an oil level measured by said sensor, communication means, such as a display or a near field communications circuit coupled to said transmission devices, for communicating to the outside of the aircraft information representing an oil level measured by said sensor. The maintenance system further comprises a mobile apparatus able to communicate with said communication means and comprising a display for displaying said information representing an oil level to an operator situated on the ground outside the aircraft.

### FIELD OF THE DISCLOSURE

According to a first aspect, embodiments of the present disclosure relate to a system for maintaining an aircraft turbine engine. According to a second aspect, embodiments of the present disclosure relate to a method for maintaining an aircraft turbine engine on the ground.

### BACKGROUND

In the aeronautical field, maintenance operations on the ground are necessary. In general, airlines require in particular to be able to easily measure the oil level in aeroplane engines between two flights, for example following a request by the pilot.

A direct measurement procedure is generally followed in order to determine the oil level. According to a first approach, an operator looks through a viewing window present on a face of the oil reservoir in order to directly view the oil level. According to a second approach, he inserts a stick (or rod, also called a dipstick) through the oil reservoir cap. By withdrawing the stick, it is possible to deduce the oil level according to the position of the portion of the stick covered with oil. The two approaches for direct measurement of the oil level may be combined.

Such a direct measurement of the oil level in an oil reservoir of an aircraft engine has certain drawbacks. When a viewing window is used, it is necessary to perform cutting, planing and tapping operations in order to obtain an oil reservoir provided with such a window. It is also necessary to implement special sealing solutions and to take into account the risks related to fire. The use of a stick or rod to be inserted through the cap of an oil reservoir involves increasing the size and complexity of this cap.

Thus the design of oil reservoirs must be specific to allow direct viewing of the oil level as is done normally. This may limit the choice of the forms of oil reservoir possible and increase the oil reservoir manufacturing cost. Moreover, a maintenance method involving direct viewing of the oil level is relatively lengthy. However, maintenance times that are as short as possible are required in order to reduce the time during which an aeroplane must remain on the ground.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect, one of the objects of the disclosure is to provide a system for maintenance of an aircraft turbine engine that allows easier maintenance of said turbine engine. To this end, one embodiments of the system for maintaining a turbine engine of an aircraft comprises:

an aircraft turbine engine further comprising:
an oil reservoir;
a sensor able to measure an oil level in the oil reservoir; and
transmission means for transmitting a signal coupled to said sensor in order to transmit information relating to an oil level measured by said sensor;

wherein said turbine engine comprises communication means, coupled to said transmission means, for communicating to the outside of the aircraft information representing an oil level measured by said sensor; and

wherein said maintenance system comprises a mobile apparatus able to communicate with said communication means and comprising display means for displaying said information representing an oil level communicated by said communication means to an operator situated on the ground outside the aircraft and carrying said mobile apparatus.

The communication means make it possible to communicate to the outside of the aircraft information representing an oil level that is measured by the sensor. To the outside of the aircraft means to the outside of the aircraft cabin intended to receive passengers and crew members. There is therefore no longer a need to provide a viewing window on the oil reservoir or a system using a stick or rod. The design of the oil reservoir can therefore be simpler (for example, it is no longer necessary to provide a specific place for a viewing window or guide for the stick). The design of the oil reservoir or reservoirs may also be more varied. The procedure for manufacturing an oil reservoir of a turbine engine is also simpler and less expensive in the disclosed subject matter, for the same reasons. The risks of leakage are also reduced. A viewing window and a guide for receiving a stick are in fact possible sources of weakness in terms of sealing.

In the system for maintaining a turbine engine discussed herein, the maintenance procedure is simpler since it suffices to read the information communicated by the communication means. There is no longer any need to go and view the oil level through a viewing window or to insert a stick through the oil reservoir cap. Compared with the use of a viewing window, the system makes it possible to have more reliable information relating to an oil level in the oil reservoir. Condensation and raindrops may for example make reading an oil level difficult and unreliable.

Various types of coupling can be imagined between the transmission means and the sensor. Examples of possible types of coupling are electromagnetic coupling and electrical coupling. In some embodiments, the transmission means are connected to the sensor for example by electrical wires, near-field communication links, etc.

Various types of communication means may be imagined, as described below. The communication means may be, for example, visual communication means such as for example display means (a screen, for example). In some embodiments, the system for maintaining a turbine engine also comprises means for receiving said signal. In some embodiments, the communication means comprise display means. The communication means may also be electrical or electromagnetic communication means.

One example of an aircraft is an aeroplane. Examples of turbine engines are turboprop engines and turbojet engines.

Various possible embodiments of the disclosure exist, which can be taken together or separately.

Thus the communication means may be, for example, able to communicate information representing an oil level measured by said sensor within a radius of no more than ten meters around said turbine engine, and in some embodiments no more than five meters.

By associating the center of gravity of the turbine engine with the center of a sphere, the communication means can then communicate information representing an oil level measured by the sensor at a distance of no more than ten (preferably five) meters measured from this sphere center.

For some embodiments, the communication means may communicate said information within a radius of no more than twenty meters around the turbine engine.

According to another possible embodiment, said display means comprise for example an LED or LCD screen. The English abbreviations LED and LCD are known to persons skilled in the art. Said display means may be, for example, carried by said oil reservoir. According to another possible embodiment, the display means are situated on a nacelle of the turbine engine. The display means may be configured to display said information continuously. According to another possible embodiment, the turbine engine also comprises control means coupled to said display means, configured to demand a display of said information. The control means comprise for example a control button or switch.

According to another possible embodiment, the communication means comprise near-field communication means. The term “near-field communication” is known to persons skilled in the art. It is typically a case of short-range high-frequency wireless communication technology (frequency in general higher than 10 MHz), allowing the exchange of information generally over a distance of no more than 1 m, or even 10 cm. The near-field communication means in some embodiments comprise an electromagnetic-wave emitter for communicating to the outside of the aircraft information relating to an oil level measured by the sensor.

In some embodiments, the communication means comprise an RFID chip. The RFID chip in some embodiments is associated with a radio tag and/or with an antenna. By using a suitable reader (a radio frequency transmitter), it is then possible to determine the oil level measured by the sensor. For example, the communication means comprise a socket to which the mobile apparatus is connected.

In some embodiments, the mobile apparatus is within a maximum radius of ten meters around said turbine engine, and in some embodiments a maximum of five meters.

In some embodiments, the maintenance system comprises processing means for processing a signal transmitted by the transmitting means and hardware and/or software based estimation means able to estimate a requirement for filling said oil reservoir from the information transmitted by the transmission means. In this embodiment, it is possible to know quickly and easily whether it is necessary to provide filling of an oil reservoir. By virtue of the processing means it is possible to use various data, and not only an absolute oil level, for the system for maintaining a turbine engine. In some embodiments, the processing and estimation means are incorporated in the mobile apparatus. In some embodiments, the mobile apparatus comprises said processing and estimation means.

In some embodiments, the system for maintaining a turbine engine comprises recording and storage means, such as computer memory, coupled to said transmission means in order to record information relating to oil levels measured by said sensor. In this embodiment, it is possible to keep a history of the oil levels determined in the past between flights. This may facilitate long-term maintenance. For example, by comparing the differences in oil level between two flights at different times, it is possible for example to deduce that the turbine engine is consuming more and more oil and that maintenance or even replacement of some parts is required. In some embodiments, the recording and storage means are included in the turbine-engine maintenance system. For example, the recording and storage means are included in the turbine engine. In another example, the recording and storage means are included in the mobile apparatus. Recording and storage means may also be present in the aircraft, for example in the cockpit, so that the stored data can be consulted for example by the pilots when the turbine engine is at rest and the transmission of information by FADEC is not available.

According to a second aspect, a method is provided for maintaining a turbine engine of an aircraft on the ground. The method comprises:

providing a turbine engine further comprising:
an oil reservoir;
a sensor able to measure an oil level in the oil reservoir;
transmission means for transmitting a signal coupled to said sensor in order to transmit information relating to an oil level measured by said sensor; and
communication means, coupled to said transmission means, for communicating to the outside of the aircraft information representing an oil level measured by said sensor;

providing, in the vicinity (for example, at a maximum of ten metres) of said turbine engine, a mobile apparatus able to communicate with said communication means and comprising display means for displaying information representing an oil level communicated by said communication means;

reading, outside the aircraft, said information communicated by the communication means by viewing a display on said mobile apparatus; and

deducing a fill level of said oil reservoir from the reading made in the previous step.

The reading of the information communicated by the communication means may be direct or indirect depending on the communication means of the system for maintaining the turbine engine (various embodiments are possible as explained for the system for maintaining a turbine engine).

The advantages presented for the system for maintaining a turbine engine according to the first aspect apply to the method for maintenance on the ground of the disclosure, mutatis mutandis. In particular, the maintenance procedure is simpler and quicker that what is done at the present time. By simple visual inspection of a display screen situated on the mobile apparatus, for example, it is possible to determine the oil level in the oil reservoir of a turbine engine. The economic gain is substantial since the maintenance operation must be shortened as much as possible in order to reduce the period of immobilization of the aircraft.

The step of providing a mobile apparatus in the vicinity of the turbine engine is preferentially adopted when the communication means comprise near-field communication means or an RFID chip. In the case of an RFID chip, the mobile apparatus carried by the operator comprises, for example, a radio frequency transmitter that will provide the necessary energy to the RFID chip for it to be able to communicate the information representing an oil level measured by the sensor. The mobile apparatus is positioned in the vicinity of the turbine engine, that is to say preferably at a maximum of ten meters and in some embodiments within a maximum radius of five meters.

According to one possible embodiment, the mobile apparatus processes the information communicated by the communication means. For example, the mobile apparatus may compare the oil level measured by the sensor with a reference threshold level for the turbine engine. The mobile apparatus can then supply an alert if the measured level is less than the reference threshold level.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIG. 1 shows an aircraft having four turbine engines; and

FIG. 2 schematically shows a possible example of the turbine engine according to the disclosure.

The drawings in the figures are not to scale. The presence of reference numerals in the drawings cannot be considered to be limiting, including when these numerals are indicated in the claims.

### DETAILED DESCRIPTION

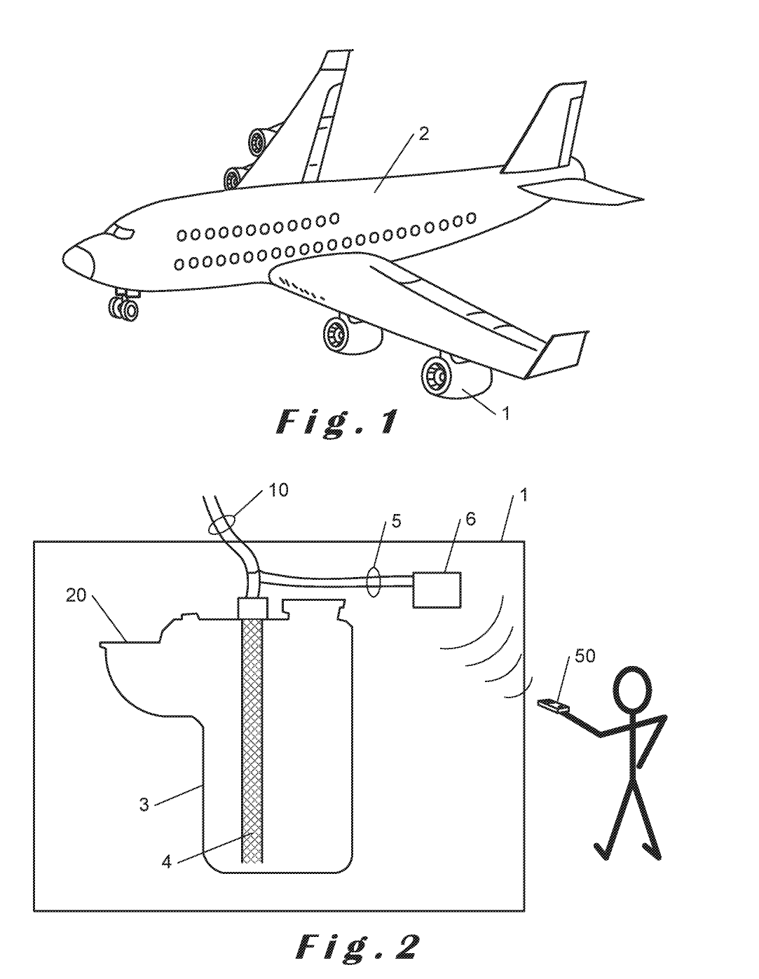

FIG. 1 shows an aeroplane, for example an aircraft 2, having four turbine engines 1. An aircraft 2 generally comprises an even number of turbine engines 1, for example two or four. The term turbine engine 1 is known to persons skilled in the art. It may for example be a turbojet engine or a turboprop engine. A turbine engine 1 generally comprises various parts, such as a fan, one or more compressors, a cooling circuit, a combustion chamber and one or more turbines.

FIG. 2 schematically shows a turbine engine 1, a mobile apparatus 50 and an operator. The turbine engine comprises one or more oil reservoirs 3 for providing the lubrication of various components. The oil reservoir 3 comprises an inlet 20 for providing oil thereto. The turbine engine 1 also comprises a sensor 4 for measuring an oil level in the oil reservoir 3. Various types of sensors known to persons skilled in the art can be used. A sensor 4 used to send information relating to an oil level to a system of the FADEC type (the interface between the cockpit and the turbine engine 1) can for example be used. This example is illustrated in FIG. 2, where electrical connections 10 make it possible to send an oil-level measurement made by the sensor 4 to the FADEC system. According to another possible variant, the turbine engine 1 comprises a specific level sensor 4, independent of a sensor that would be used for sending oil-level information to the FADEC system or to the cockpit.

A transmitter or transmission means 5 are coupled to the sensor 4 in order to transmit information relating to an oil level measured by the sensor 4. As illustrated in FIG. 2, the transmission means 5 or transmitter may, for example, be electrical wires connected to the electrical connections 10 used for relaying oil-level information to the FADEC system. This is for example the case when the level sensor 4 is also used for informing the FADEC system or a cockpit on the oil level of an oil reservoir 3. Other methodologies for transmitting information relating to oil level may be practiced with embodiments of the present disclosure.

The system for maintaining a turbine engine 1 also comprises communication means 6, coupled to the transmission means 5, for communicating to the outside of the aircraft 2 (to the outside of the cabin of the aircraft 2 more precisely) information representing an oil level measured by said sensor 4. As illustrated in FIG. 2, the communication means 6 make it possible to communicate with a mobile apparatus 50 situated outside the turbine engine. The mobile apparatus 50 comprises display means such as a screen, for example of the LCD or LED type.

Display means may for example be situated on an external surface of the oil reservoir 3 or on a nacelle of the turbine engine 1, for example in the vicinity of a service hatch (in the latter case it is not necessary to open said service hatch to view the information given by the display means). Such display means can be configured to display information relating to an oil level in a continuous or non-continuous manner. If the display means are situated on an external surface of the oil reservoir and comprise control means for example, a capacitor could be charged when pressing on the control means to activate the display.

The mobile apparatus 50 in some embodiments comprises control means coupled to the display means for controlling whether or not information relating to an oil level of the oil reservoir 3 is displayed. For example, the control means comprise a control button or switch that can be activated by an operator in order to determine an oil level measured by the sensor 4. The oil level measured by the sensor 4 is transmitted to the mobile apparatus 50 by virtue of the transmission 5 and communication means 6 of the turbine engine. Such a control button could also be used to validate the fact that the oil reservoir 3 has been filled. The use of display means also makes it possible to indicate that an operation of filling an oil reservoir 3 has been performed. This also facilitates and shortens the procedure for filling an oil reservoir 3 of a turbine engine 1.

According to another possible embodiment, the communication means 6 comprise an RFID chip or near-field communication means in order to be able to communicate with a mobile apparatus 50 for example. Other wireless or wired examples or protocols are possible in order to be able to communicate with a mobile apparatus 50, including, but not limited to, Bluetooth, infrared, and Wi-Fi protocols.

The system for maintaining a turbine engine 1 may also comprise processing means for processing a signal transmitted by the transmission means 5. It is then possible to supply quantities other than an oil level to an operator. By virtue of these processing means, it is possible for example to display a need to fill an oil reservoir 3. Such a need can be identified on the basis of measurements during previous flights, calculations (consumption of previous flights for example) or recorded data (typical tasks, predefined margins) for example. The processing means can be hardware, software, or combinations of hardware and software. In some embodiments, the processing means can include logic circuits, processors, microprocessors, controllers, etc.

A procedure is therefore provided for maintaining a turbine engine 1 on the ground where, by virtue of the communication means 6, an operator will be able to read, on the ground, with a mobile apparatus 50, information relating to an oil level measured by the sensor 4. When the communication means 6 comprise display means (for example, a display, an LED or LCD screen, etc.), the reading is direct. When the communication means 6 is or comprises near-field communication means or an RFID chip, the reading is indirect and performed with a mobile apparatus 50. The operator then typically uses a mobile apparatus 50 or a box or reader that can read the information communicated by the communication means 6. This mobile apparatus 50 comprises display means such as a screen on which information relating to an oil level measured by the sensor 4 is displayed.

Reading the information communicated by the communication means 6 (directly or indirectly) makes it possible to deduce a filling state of the oil reservoir 3.

In the context of the present disclosure, the oil reservoir 3, the sensor 4, the transmission means 5 and the communication means 6 are described as belonging to the turbine engine 1. This wording cannot be used to limit the scope of the claimed subject matter.

Aspects of the present disclosure have been described in relation to specific embodiments, which have a purely illustrative value and must not be considered to be limiting. In general terms, aspects of the present disclosure are not limited to the examples illustrated and/or described above. The use of the verbs “comprise”, “include”, “have” or any other variant, as well as conjugations thereof, can in no way exclude the presence of elements other than those mentioned. The use of the indefinite article “a” or “an”, or of the definite article “the”, to introduce an element does not exclude the presence of a plurality of these elements. The reference numerals in the claims do not limit their scope.

Systems are provided for maintaining a turbine engine 1 of an aircraft 2, comprising: an oil reservoir 3, a sensor 4 able to measure an oil level in the oil reservoir 3, transmission means 5 for transmitting a signal coupled to said sensor 4 in order to transmit information relating to an oil level measured by said sensor 4, communication means 6, coupled to said transmission means 5 for communicating to the outside of the aircraft 2 information representing an oil level measured by said sensor to a mobile apparatus 50 able to communicate with the communication means 6, the mobile apparatus 50 comprising display means for displaying information representing an oil level communicated by the communication means 6 to an operator situated on the ground outside the aircraft 2.

Thus these systems make it possible to obtain, in the vicinity of a turbine engine 1 at rest, information relating to an oil level in an oil reservoir 3. Structurally speaking, the system is distinguished from the prior art at least by the fact that the display of information relating to an oil level in an oil reservoir 3 takes place on or in the vicinity of the oil reservoir 3. For this purpose, the oil reservoir 3 or the turbine engine 1 is equipped with communication means 6 so that an operator can have access to the oil level either directly or by means of a mobile apparatus 50 that would be passed close to these communication means 6 (of the RFID type for example).

While illustrative embodiments have been illustrated and described, it will be appreciated that various changes can be made therein without departing from the spirit and scope of the claimed subject matter.

1. System for maintenance of a turbine engine of an aircraft comprising:
a turbine engine further comprising:
an oil reservoir;
a sensor able to measure an oil level in the oil reservoir; and
a transmitter configured for transmitting a signal coupled to said sensor in order to transmit information relating to an oil level measured by said sensor;
wherein said turbine engine comprises communication means, coupled to said transmitter, for communicating to the outside of the aircraft information representing an oil level measured by said sensor; and
wherein said maintenance system comprises a mobile apparatus able to communicate with said communication means and comprising a display configured for displaying said information representing an oil level communicated by said communication means to an operator situated on the ground outside the aircraft.

2. The maintenance system of claim 1, wherein said communication means are able to communicate information representing an oil level measured by said sensor within a radius of no more than ten meters around said turbine engine.

3. The maintenance system of claim 1, wherein said display of said mobile apparatus comprises an LED or LCD screen.

4. The maintenance system of claim 1, wherein said display is configured to display said information permanently.

5. The maintenance system of claim 1, wherein said mobile apparatus comprises a control coupled to said display, configured to control the display of said information.

6. The maintenance system of claim 1, wherein said communication means comprise near-field communication means.

7. The maintenance system of claim 1, wherein said communication means comprise an RFID chip.

8. The maintenance system of claim 1, wherein said mobile apparatus is within a maximum radius of ten meters around said turbine engine.

9. The maintenance system of claim 1, further comprising processing means for processing a signal transmitted by the transmitter and estimation means able to estimate a requirement for filling said oil reservoir from the information transmitted by the transmitter.

10. The maintenance system of claim 9, wherein said processing and estimation means are incorporated in said mobile apparatus.

11. The maintenance system of claim 1, further comprising recording and storage means coupled to said transmitter for recording information relating to oil levels measured by said sensor.

12. Method for maintaining a turbine engine of an aircraft on the ground and comprising:
providing a turbine engine further comprising:
an oil reservoir;
a sensor able to measure an oil level in the oil reservoir;
a transmitter for transmitting a signal coupled to said sensor in order to transmit information relating to an oil level measured by said sensor; and
communication means, coupled to said transmitter, for communicating to the outside of the aircraft information representing an oil level measured by said sensor;
providing, in the vicinity of said turbine engine, a mobile apparatus able to communicate with said communication means and comprising a display for displaying information representing an oil level communicated by said communication means;
reading, outside the aircraft, said information communicated by the communication means by viewing a display on said mobile apparatus; and
deducing a fill level of said oil reservoir from said reading.

13. The method of claim 12, comprising processing, by said mobile apparatus, the information communicated by said communication means.

14. The method of claim 12, wherein said mobile apparatus is provided within a maximum radius of ten meters around said turbine engine.
